(19) United States
(12) Patent Application Publication
(10) Pub. No.: US 2026/0210278 A1
(43) Pub. Date: Jul. 23, 2026

(54) EXHAUST TREATMENT SYSTEM, METHOD FOR TREATMENT OF AN EXHAUST STREAM AND CONTROL SYSTEM THEREFORE

(71) Applicant: Scania CV AB, Södertälje (SE)

(72) Inventors: Magnus NILSSON, Mörkö (SE); Henrik BIRGERSSON, Stockholm (SE)

(73) Assignee: Scania CV AB, Södertälje (SE)

(21) Appl. No.: 19/138,486

(22) PCT Filed: Dec. 8, 2023
(86) PCT No.: PCT/SE2023/051234

§ 371 Date: Jun. 12, 2025

(30) Foreign Application Priority Data
Dec. 19, 2022 (SE) 2251494-7

(51) Int. Cl. F01N 13/00; B01D 53/90; B01D 53/94; F01N 3/022; F01N 3/10; F01N 3/20

(52) U.S. Cl. CPC F01N 13/009; B01D 53/90; B01D 53/9418; B01D 53/9477; F01N 3/0222; F01N 3/106; F01N 3/2066; B01D 2251/2067; B01D 2257/404; B01D 2258/01; F01N 2570/18; F01N 2610/02

(57) ABSTRACT

An exhaust treatment system is disclosed comprising a filter structure arranged downstream of a dosing arrangement to interact with particles in an exhaust stream created by a supply of additive into the exhaust stream and a transformation of the additive when flowing through the exhaust treatment system. The filter structure has a cross section area A in inches² and a length L in inches resulting in an area to length ratio A/L having a value of at least 17 inches; A/L≥17 inches, and has an opening degree such that: the particles are caused to interact with the filter structure, thereby being at least partly captured and removed from the exhaust stream; and accumulation of soot and ash created by the combustion, which would affect the interaction of the filter structure and the particles, is at least partly avoided.

### CROSS-REFERENCE TO RELATED APPLICATIONS

This application is a National Stage Patent Application (filed under 35 § U.S.C. 371) of PCT/SE2023/051234, filed Dec. 8, 2023, of the same title, which, in turn claims priority to Swedish Patent Application No. 2251494-7 filed Dec. 19, 2022, of the same title; the contents of each of which are hereby incorporated by reference.

### TECHNICAL FIELD

The present invention relates to an exhaust treatment system, a method for treatment of an exhaust stream, and a control system for controlling the exhaust treatment system to perform the method.

The invention also relates to a computer program and a computer program product, which implement the method according to the invention.

### BACKGROUND

The following background description constitutes a description of the background to the present invention, and thus need not necessarily constitute prior art.

In connection with increased government interests concerning pollution and air quality, primarily in urban areas, emission standards and regulations regarding emissions from combustion engines have been drafted in many jurisdictions.

Such emission standards often consist of requirements defining acceptable limits of exhaust emissions from combustion engines in for example vehicles. For example, emission levels of nitrogen oxides NOₓ, hydrocarbons CₓH_{y}, carbon monoxide CO and particles PM are often regulated by such standards for most types of vehicles. Vehicles equipped with combustion engines typically give rise to such emissions in varying degrees. In this document, the invention will be described mainly for its application in vehicles, i.e. for internal combustion engines. However, the invention may be used in substantially all applications where combustion engines are used, for example in vessels such as ships or aeroplanes/helicopters, wherein regulations and standards for such applications limit emissions from the combustion engines.

In an effort to comply with these emission standards, the exhausts caused by the combustion of the combustion engine are treated (purified).

A common way of treating exhausts from a combustion engine consists of a so-called catalytic purification process, which is why vehicles equipped with a combustion engine usually comprise at least one catalyst. There are different types of catalysts, where the different respective types may be suitable depending on for example the combustion concept, combustion strategies and/or fuel types which are used in the vehicles, and/or the types of compounds in the exhaust stream to be purified. In relation to at least nitrous gases (nitrogen monoxide, nitrogen dioxide), referred to below as nitrogen oxides NOₓ, vehicles often comprise a catalyst, wherein an additive is supplied to the exhaust stream resulting from the combustion in the combustion engine, in order to reduce nitrogen oxides NOₓ, primarily to nitrogen gas and aqueous vapour. This is described in more detail below.

SCR (Selective Catalytic Reduction) catalysts are a commonly used type of catalysts for this type of reduction, primarily for heavy goods vehicles. SCR catalysts usually use ammonia NH₃, or a composition from which ammonia may be generated/formed, as an additive to reduce the amount of nitrogen oxides NOₓ in the exhausts. The additive, for example urea, is injected into the exhaust stream resulting from the combustion engine upstream of the catalyst. The additive added to the catalyst is adsorbed (stored) in the catalyst, in the form of ammonia NH₃, so that a redox-reaction may occur between nitrogen oxides NOₓ in the exhausts and ammonia NH₃ available via the additive.

### SUMMARY

When the additive is injected into the exhaust stream, i.e. when the additive is supplied into the exhaust treatment system, small particles may be created from the additive at the injection. Also, when the injected additive travels with the exhaust stream through the components of the exhaust treatment system, further small particles may be created from the additive due to the treatment of the exhaust stream performed by the components of the exhaust treatment system. Thus, these small additive based particles are created from the additive at the injection and/or from various transformations of the additive when flowing through the exhaust treatment system. The particles may therefore comprise urea and/or polymeric biproducts based on urea, depending on where in the exhaust treatment system they are created.

These small additive based particles may for example have a diameter in the interval of 10 to 23 nm, and may flow with the exhaust stream through the entire exhaust treatment system and be emitted at the tailpipe. Thus, at least a portion of these additive based particles may, e.g. due to their small size, pass through each of the components of the exhaust treatment system, also through the SCR catalysts, and may be emitted into the environment as emissions. The additive based particles may also comprise combustion based particles, i.e. particles created at the combustion in the combustion engine. Thus the small-sized particles may then, due to interaction and/or mixing with particles from the combustion, comprise a mixture of additive based particles and soot and/or ash. The small particles may, if being emitted, have health effects.

One objective of the present invention is to at least partly prevent these small additive based particles from being emitted into the environment.

The objective is achieved through the above mentioned exhaust treatment system arranged for treatment of an exhaust stream resulting from a combustion in a combustion engine, the exhaust treatment system comprising:
a particulate filter arranged to catch soot and ash created by the combustion;
a dosing arrangement arranged downstream of the particulate filter to supply an additive into the exhaust stream;
a reduction catalyst arrangement arranged downstream of the dosing arrangement for reduction of nitrogen oxides NOₓ in the exhaust stream by utilization of the supplied additive;
   and
at least one filter structure arranged downstream of the dosing arrangement to interact with particles in the exhaust stream, the particles being created by one or more of the supply of the additive into the exhaust stream and a transformation of the additive when flowing through the exhaust treatment system, wherein the at least one filter structure has a cross section area A in inches² and a length L in inches resulting in an area to length ratio A/L having a value of at least 17 inches; A/L≥17 inches, and has an opening degree such that:
   the particles are caused to interact with the at least one exhaust stream interaction arrangement, thereby being at least partly captured and removed from the exhaust stream; and
   accumulation of soot and ash created by the combustion, which would affect the interaction of the at least one filter structure and the particles, is at least partly avoided.

Hereby, the small additive based particles are at least partly removed from the exhaust stream before the exhaust stream is emitted from the tailpipe. Thus, these small particles, possibly having a diameter in the interval of 10 to 23 nm, are dissolved by the interaction with the at least one exhaust stream interaction arrangement, and are at least partly hindered from leaving the tailpipe.

Combustion based particles, such as soot and/or ash created in the combustion engine and present in the exhaust stream downstream of the particulate filter, may be accumulated to a small degree in the at least one exhaust stream interaction arrangement, as long as the accumulation does not have a negative effect on the interaction between the at least one filter structure and the additive based particles.

An essential feature is the ratio between the area A of the cross section and the length L of the at least one filter structure. The at least one filter structure has a cross section area A in inches² and a length L in inches resulting in an area to length ratio A/L having a value of at least 17 inches; A/L≥17 inches. This defines the at least one filter structure to have a shorter length L in relation to the area A, such that it has a higher value for the area to length ratio A/L, than conventional particulate filters have. The at least one filter structure is thus specifically designed not to capture all particles in the exhaust stream, since a shorter filter structure generally provides less efficient filtration. The at least one filter structure is in other words designed to be a mediocre/poor filter in the conventional meaning of a filter, i.e. to provide a low filtering efficiency at least regarding capture of soot and ash particles. The hereby defined at least one filter structure would therefore not suffice, i.e. would not be efficient enough, to use as a particulate filter itself, since it catches far less soot and ash particles than a conventional particulate filter would catch.

Tests have shown that the at least one filter structure, although being a poor filter in the conventional sense of catching large soot and ash particles, surprisingly efficiently catches and removes the above mentioned additive based small particles, i.e. the small particles being created by the supply of additive into the exhaust stream and/or the transformation of the additive. Thus, the at least one filter structure overcomes the technical prejudice that highly efficient filters must be used for removing small particles from the exhaust stream, since the at least one filter structure, designed for providing a poor filtering in the conventional sense, provides an unexpected efficient catch and removal of these small particles.

The small size, i.e. the short length L in relation to the cross section area A, of the at least one filter structure makes it possible to implement it essentially anywhere in applicable parts of the exhaust treatment system.

Due to the small size, defined by the A/L ratio, the at least one filter structure causes only a low back pressure on the exhaust stream. Hereby, the impact the at least one filter structure has on other exhaust treatment processes in the exhaust treatment system is minimized, such that the overall exhaust gas treatment is essentially unaffected.

The exhaust treatment system according to the present invention has potential to meet the emission requirements in current and/or future emission standards, and may be efficiently implemented in small size.

According to an embodiment, the at least one filter structure is closed.

The at least one filter structure may hereby be implemented in a closed and small-sized filter structure, which enables high efficiency and capacity for the removal of the additive based particles from the exhaust stream. The particulate filter makes it possible to arrange the at least one filter structure as a closed filter structure variant, since the particulate filter captures the majority of the soot and ash particles resulting from the combustion in the combustion engine.

According to an embodiment, the at least one filter structure comprises channels, each channel being closed at one or more in the group of:
at its upstream end;
at its downstream end; and
between its upstream and downstream ends.

By utilizing closed filter channels, a closed filter structure may be provided, which enables efficient removal of the additive based particles from the exhaust stream.

According to an embodiment, the opening degree of the at least one filter structure is zero.

The closed filter structure enables efficient removal of the additive based particles from the exhaust stream.

According to an embodiment, the area to length ratio A/L in inches for the at least one filter structure has a value of at most 50; 17≤A/L≤50 inches.

With this interval for the area to length ratio A/L, a small-sized and efficient filter structure, which is arranged in a closed filter structure, is provided.

Also, when the area to length ratio A/L in inches for the at least one filter structure has a value of at most 50, it is possible to coat the at least one filter structure with a catalytically active material.

According to an embodiment, the at least one filter structure comprises one or more channels being open through the filter structure.

Hereby, the at least one filter structure may be implemented in a non-closed filter structure, e.g. in an open filter structure.

The open filter structure results in a very low back pressure from the at least one filter structure on the exhaust stream. Hereby, the impact the at least one filter structure has on other exhaust treatment processes in the exhaust treatment system is minimized, such that the overall exhaust gas treatment is essentially unaffected. Also, a robustness over time for a service free component is increased.

According to an embodiment, the opening degree of the at least one filter structure is in one of the intervals in the group of:
1% to 80%;
10% to 80%;
20% to 80%;
10% to 60%;
20% to 60%;
10% to 50%;
20% to 50%; and
30% to 50%.

In the presented intervals for the opening degree, efficient removal of the additive based particles without harmful accumulation of soot and ash is provided for various implementations of the at least one filter structure.

According to an embodiment, the area to length ratio A/L for the at least one filter structure has a value of at least 17 inches and at most 100 inches; 17≤A/L≤100 inches.

Within this interval for the area to length ratio A/L, an efficient at least one filter structure implemented in an at least partly open filter structure is provided. The non-closed filter structure enables the at least one filter structure to have an even smaller size, i.e. to have an even smaller length L in relation to the cross section area A, compared to a closed filter structure. Thus, the area to length ratio may have higher values for the open structure compared to the closed structure.

According to an embodiment
the at least one filter structure comprises at least one open channel and at least one closed channel through the at least one filter structure;
the at least one open channel has an open channel cross section area A_{oc}; and
the at least one closed channel has a closed channel cross section area A_{cc}, the closed channel cross section area A_{cc} being essentially equal to the open channel cross section area A_{oc}; A_{oc}=A_{cc}.

Hereby, a symmetric at least one filter structure design is provided, with similar size, i.e. cross section areas, for all channels in the at least one filter structure.

According to an embodiment
the at least one filter structure comprises at least one open channel and at least one closed channel through the at least one filter structure;
the at least one open channel has an open channel cross section area A_{oc}; and
the at least one closed channel has a closed channel cross section area A_{cc}, the closed channel cross section area A_{cc} being different from the open channel cross section area A_{oc}.

Hereby, an asymmetric at least one filter structure design is provided, with different, i.e. non-similar size, such as cross section areas, for the channels in the filter. According to some embodiments, the open channels have a smaller cross section area than the closed channels have.

According to an embodiment, wherein the at least one filter structure is arranged at least 0.1 meter downstream of the dosing arrangement.

Hereby, the at least one filter structure is separated from the dosing arrangement, such that it does not affect the injection of additive into the exhaust stream. Thus, the at least one filter structure is by this placement arranged to interact with, and remove, the small additive based particles. However, the injected additive intended to be used by the catalysts in the system still reaches the catalysts, such that efficient reduction of nitrogen oxides NOₓ is provided.

According to an embodiment, wherein the exhaust treatment system further comprises an evaporation arrangement arranged at the dosing arrangement, whereby the at least one filter structure is arranged downstream of the evaporation arrangement.

Hereby, the at least one filter structure is separated from the evaporation arrangement, such that it does not affect its function.

According to an embodiment, the at least one filter structure is arranged upstream of the reduction catalyst arrangement.

By this position of the at least one filter structure between the dosing arrangement and the reduction catalyst arrangement, an efficient removal of the additive based particles is provided. Also, since the exhaust stream here still comprises plenty of nitrogen oxides NOₓ, including both nitrogen dioxide NO₂ and nitrogen monoxide NO, passive oxidation of captured soot and/or ash is facilitated.

According to an embodiment, the at least one filter structure is comprised in the reduction catalyst arrangement.

By this position of the at least one filter structure as integrated in the reduction catalyst arrangement, an efficient removal of the additive based particles is provided which does not add to the size of the system. Thus, the added at least one filter structure may be fitted within an existing exhaust treatment system/box/silencer.

Also, passive oxidation of caught soot and/or ash is here possible since the exhaust stream comprises plenty of nitrogen oxides NOₓ, including both nitrogen dioxide NO₂ and nitrogen monoxide NO.

Also, synergies between catalytic efficiency improvements and filtration efficiency may be provided according to this embodiment, i.e. with the at least one filter structure as integrated in the reduction catalyst arrangement.

According to an embodiment, the at least one filter structure is arranged downstream of the reduction catalyst arrangement.

Hereby, the at least one filter structure does not affect the performance of the reduction catalyst arrangement.

According to an embodiment, wherein the exhaust treatment system further comprises a slip catalyst arrangement arranged downstream of the reduction catalyst arrangement for oxidation of a residue of additive in the exhaust stream, the at least one filter structure is arranged downstream of the reduction catalyst arrangement and upstream of the slip catalyst arrangement.

At this position, an efficient function of the at least one filter structure may be provided.

According to an embodiment, wherein the exhaust treatment system further comprises a slip catalyst arrangement arranged downstream of the reduction catalyst arrangement for oxidation of a residue of additive in the exhaust stream, the at least one filter structure is comprised in the slip catalyst arrangement.

By this position of the at least one filter structure as integrated in the slip catalyst, a removal of the additive based particles is provided which does not add to the size of the system. Thus, the added at least one filter structure may be fitted within an existing exhaust treatment system/box/silencer.

According to an embodiment, wherein the exhaust treatment system further comprises a slip catalyst arrangement arranged downstream of the reduction catalyst arrangement for oxidation of a residue of additive in the exhaust stream, the at least one filter structure is arranged downstream of the slip catalyst arrangement.

At this position, an efficient function of the at least one filter structure may be provided. Also, this placement of the at least one filter structure provides for a design freedom regarding e.g. the shape and/or location of the at least one exhaust stream interaction arrangement.

According to an embodiment, the reduction catalyst arrangement comprises one or more in the group of:
at least one selective catalytic reduction catalyst;
at least one slip catalyst.

Hereby, an efficient removal of nitrogen oxides NOₓ may be provided.

According to an embodiment
the at least one filter structure comprises at least one section arranged to be heated to an interaction temperature T_{I} by the exhaust stream flowing through it, the interaction temperature T_{I} exceeding a particle temperature T_{P} at which the particles thermally dissolve; T_{I}>T_{P}; and
the at least one filter structure is arranged to interact with the particles such that the particles at least partly come in physical contact with the heated at least one section.

Thus, the additive based particles are efficiently dissolved by the at least one filter structure which is at least partly heated by the exhaust stream.

According to an embodiment, the interaction temperature T_{I} is at least 150° C.

When the interaction temperature T_{I} reaches and/or exceeds 150° C., the additive based particles are efficiently dissolved and thus removed from the exhaust stream. Thus, if the interaction temperature T_{I} initially is lower than 150° C., some particles may at first be accumulated in the at least one exhaust stream interaction arrangement. Then, when the interaction temperature T_{I} reaches 150° C., these accumulated particles are dissolved.

According to an embodiment, the at least one filter structure at least partially comprises an inert material.

Thus, the additive based particles are here efficiently thermally dissolved by heat.

According to an embodiment, the inert material is one or more in the group of:
a metallic material; and
a non-metallic material.

Thus, a number of materials and/or mixes of materials may be utilized in the at least one filter structure for removing the additive based particles. Hereby, an implementation flexibility regarding utilized materials is provided. In different implementations, materials such as cordierite, silicon carbide, aluminum titanate and/or polymer composites may be used.

According to an embodiment, the at least one filter structure at least partially comprises an active catalytic material.

Hereby, the additive based particles may be dissolved by use of an active catalytic material, which may possibly also have other functions in the exhaust treatment system. Hereby, an efficient solution which takes up no, or very little, extra space is provided.

According to an embodiment, the material is coated on the at least one exhaust stream interaction arrangement.

Thus, the material being used for removing the additive based particles, which may be an inert or a catalytically active material, may be coated on the at least one exhaust stream interaction arrangement. The coating of the material may improve the efficiency for the at least one filter structure regarding capturing and dissolving of the particles.

Also, coating makes it possible for the added at least one filter structure to be fitted within an existing exhaust treatment system/box/silencer.

According to an embodiment, the additive comprises one or more in the group of:
ammonia, and
a substance from which ammonia may be extracted and/or released

The ammonia is used by the one or more reduction catalyst arrangements in the exhaust treatment system for their reduction of nitrogen oxides NOₓ in the exhaust stream. Hereby, an efficient reduction of nitrogen oxides NOₓ in the exhaust stream may be provided.

According to an embodiment, the particles comprise one or more in the group of:
urea; and
polymeric biproducts based on urea.

Thus, the additive based particles are relatively instable and may be dissolved by the least one filter structure. The particles may alternatively be captured by the least one filter structure.

According to an embodiment, the exhaust treatment system comprises:
an upstream dosing device arranged to supply an additive into the exhaust stream;
an upstream reduction catalyst device arranged downstream of the upstream dosing device for reduction of nitrogen oxides NOₓ in the exhaust stream by utilizing the supplied additive;
the particulate filter arranged downstream of the upstream reduction catalyst device to catch soot and ash created by the combustion;
the dosing arrangement arranged as a downstream dosing device downstream of the particulate filter to supply an additive into the exhaust stream;
the reduction catalyst arrangement arranged as a downstream reduction catalyst device downstream of the downstream dosing device to reduce nitrogen oxides NOₓ in the exhaust stream by utilizing the supplied additive; and
the least one filter structure arranged downstream of the downstream dosing device.

The upstream and downstream reduction catalyst devices may be optimized individually, and with consideration of the entire exhaust treatment system's function, which may result in an overall very efficient purification of the exhausts. This individual optimization may also be used to reduce one or several of the volumes taken up by the upstream and downstream reduction catalyst devices, so that a compact exhaust treatment system is obtained.

Also, the two additive dosing devices in the system makes it possible to adjust the amount of additive being injected by the upstream and downstream dosing devices, respectively. Thus, by an active control of the upstream and downstream dosing, respectively, the amount of additive and/or of the additive based particles at the downstream reduction catalyst arrangement may be controlled to be suitable for efficient reduction of nitrogen oxides NOₓ and/or for keeping the additive based particles at a reasonable level, in relation to allowed emission levels.

According to an embodiment, the upstream reduction catalyst device comprises one or more in the group of:
an upstream selective catalytic reduction catalyst; and
an upstream slip catalyst.

Hereby, a flexible exhaust treatment system is provided, which efficiently reduces the nitrogen oxides NOₓ in the exhaust stream.

The above-mentioned objective is achieved also through the above-mentioned method for treatment of an exhaust stream resulting from a combustion in a combustion engine. The method comprises:
catching soot and ash created by the combustion by utilization of a particulate filter;
controlling a supply of an additive into the exhaust stream by utilization of a dosing arrangement arranged downstream of the particulate filter;
reduction of nitrogen oxides NOₓ in the exhaust stream by utilization of the supplied additive and a reduction catalyst arrangement arranged downstream of the dosing arrangement; and
interaction of particles in the exhaust stream and at least one filter structure arranged downstream of the dosing arrangement, the particles being created by one or more of the supply of the additive into the exhaust stream and a transformation of the additive when flowing through the exhaust treatment system, wherein the at least one filter structure has a cross section area A in inches² and a length L in inches resulting in an area to length ratio A/L having a value of at least 14 inches; A/L≥17 inches; and has an opening degree such that:
   the particles are caused to interact with the at least one filter structure, thereby being at least partly captured and removed by the at least one filter structure; and
   accumulation of soot and ash created by the combustion, which would affect the interaction of the at least one filter structure and the particles, is at least partly avoided.

The method has corresponding advantages as stated above for the exhaust treatment system.

The above-mentioned objective is also achieved through the above-mentioned control system arranged for treatment of an exhaust stream resulting from a combustion in a combustion engine. The treatment comprises:
catching soot and ash created by the combustion by utilization of a particulate filter;
controlling a supply of an additive into the exhaust stream by utilization of a dosing arrangement arranged downstream of the particulate filter;
reduction of nitrogen oxides NOₓ in the exhaust stream by utilization of the supplied additive and a reduction catalyst arrangement arranged downstream of the dosing arrangement; and
interaction of particles in the exhaust stream and at least one filter structure arranged downstream of the dosing arrangement, the particles being created by one or more of the supply of the additive into the exhaust stream and a transformation of the additive when flowing through the exhaust treatment system, wherein the at least one filter structure has a cross section area A in inches² and a length L in inches resulting in an area to length ratio A/L having a value of at least 14 inches; A/L≥17 inches; and has an opening degree such that:
   the particles are caused to interact with the at least one filter structure, thereby being at least partly captured and removed by the at least one filter structure; and
   accumulation of soot and ash created by the combustion, which would affect the interaction of the at least one filter structure and the particles, is at least partly avoided.

The control system has corresponding advantages as stated above for the exhaust treatment system.

The above-mentioned objective is also achieved through the above-mentioned computer program and computer program product.

The computer program and computer program product, respectively, has corresponding advantages as stated above for the exhaust treatment system.

### BRIEF LIST OF FIGURES

The invention will be illustrated in more detail below, along with the enclosed drawings, where similar references are used for similar parts, and where:

FIG. 1 shows an example vehicle which may comprise an exhaust treatment system according to various embodiments of the present invention,

FIG. 2a shows an example of an exhaust treatment system in which the aspects and embodiments of the present invention may be implemented,

FIG. 2b shows various embodiments of the implementation of the present invention in an exhaust treatment system,

FIG. 3a shows an example of an exhaust treatment system in which the aspects and embodiments of the present invention may be implemented,

FIG. 3b shows various embodiments of the implementation of the present invention in an exhaust treatment system,

FIG. 4 shows a flow chart for the method for exhaust treatment according to the invention,

FIG. 5 shows a control device according to the present invention, and

FIGS. 6a-b show non-limiting examples of filter structures.

### DESCRIPTION OF PREFERRED EMBODIMENTS

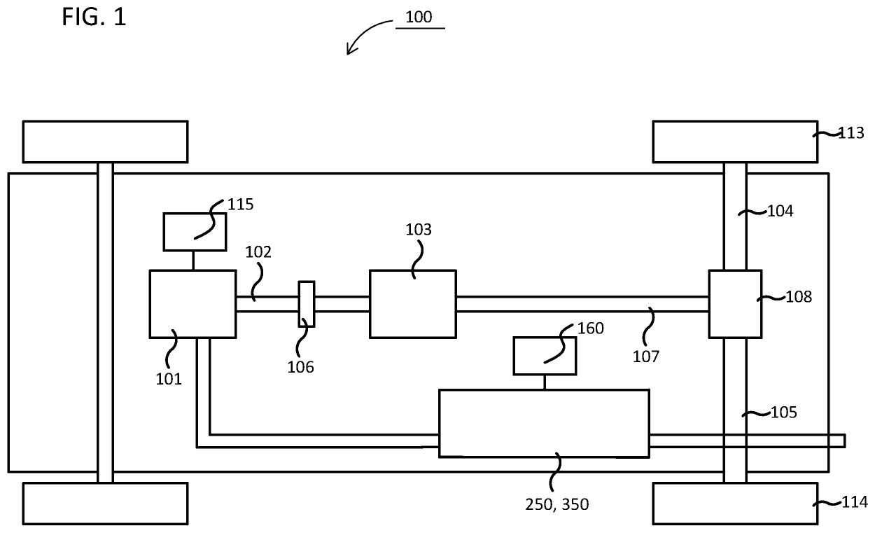

FIG. 1 schematically shows an example vehicle 100 comprising an exhaust treatment system 250, 350, which may be an exhaust treatment system 250, 350 according to an aspect or embodiment of the present invention. The powertrain comprises a combustion engine 101, which in a customary manner, via an output shaft 102 of the combustion engine 101 is connected to a gearbox 103 via a clutch 106. An output shaft 107 from the gearbox 103 may drive the wheels 113, 114 e.g. via a final drive 108, such as e.g. a customary differential, and the drive shafts 104, 105 connected to the final drive 108.

The combustion engine 101, e.g. an internal combustion engine, may be controlled by the engine's control system via a control device 115. Likewise, the clutch 106 and the gearbox 103 may be controlled by the vehicle's control system, with the help of one or more applicable control devices (not shown). Naturally, the vehicle's powertrain may also be of another type, such as a type with a conventional automatic gearbox, of a type with a hybrid powertrain, etc.

The vehicle 100 also comprises an exhaust treatment/purification system 250, 350 for treatment/purification of exhaust emissions resulting from combustion in the combustion chamber of the combustion engine 101.

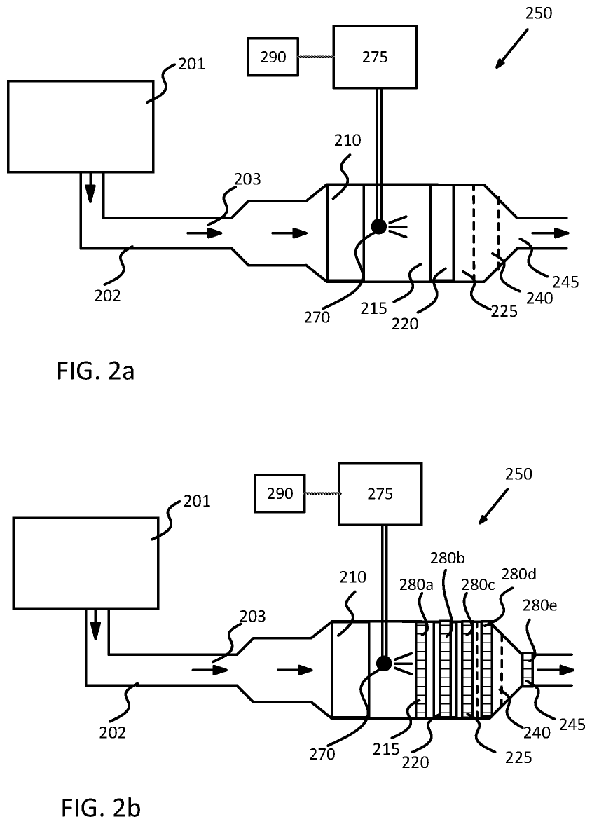

FIG. 2a shows an exhaust treatment system 250, which may illustrate a so-called Euro VI-system. The exhaust treatment system 250 is connected to a combustion engine 201 e.g. via an exhaust conduit 202, wherein the exhausts generated at the combustion, that is to say the exhaust stream 203, is indicated with arrows. The exhaust stream 203 is led to a coated diesel particulate filter (cDPF) 210, which is coated with a catalytically oxidizing coating, for example comprising at least one precious metal. Alternatively, a diesel oxidation catalyst (DOC) followed downstream by an uncoated diesel particulate filter (DPF) or a coated diesel particulate filter (cDPF) may be arranged in the exhaust treatment system 250 instead of the coated diesel particulate filter (cDPF). Thus, either of a coated diesel particulate filter (cDPF) 210 and a diesel oxidation catalyst (DOC) followed by a diesel particulate filter (DPF/cDPF) is arranged downstream of the combustion engine 201 in the exhaust treatment system 250.

During the combustion in the combustion engine 201, soot and ash are created, and the coated diesel particulate filter (cDPF) 210, or alternatively the diesel particulate filter (DPF), is used to catch the soot and ash. The exhaust stream 203 is here led through a filter structure, wherein soot and ash from the exhaust stream 203 are caught when passing through, and are stored in the particulate filter 210.

The catalytic coating in the coated diesel particulate filter (cDPF) 210, or alternatively in the oxidation catalyst (DOC), has several functions and is normally used primarily to oxidize, during the exhaust treatment, remaining hydrocarbons CₓH_{y} (also referred to as HC) and carbon monoxide CO in the exhaust stream 203 into carbon dioxide CO₂ and water H₂O. Also, a large fraction of the nitrogen monoxides NO occurring in the exhaust stream may be oxidized into nitrogen dioxide NO₂. The oxidation of nitrogen monoxide NO into nitrogen dioxide NO₂ is important to the nitrogen dioxide-based soot and ash oxidation in the filter, and is also advantageous at a potential subsequent reduction of nitrogen oxides NOₓ.

In this respect, the exhaust treatment system 250 further comprises a reduction catalyst arrangement 220 arranged downstream of the coated diesel particulate filter (cDPF) 210. The reduction catalyst arrangement 220 may comprise at least one selective catalytic reduction (SCR) catalyst and/or at least one slip catalyst. The reduction catalyst arrangement 220 uses ammonia NH₃, or a composition from which ammonia may be generated/formed, e.g. urea, as an additive for the reduction of nitrogen oxides NOₓ in the exhaust stream 203. After passing through the components of the exhaust treatment system, the exhaust stream is emitted into the environment at the tailpipe.

The reaction rate of this reduction is impacted, however, by the ratio between nitrogen monoxide NO and nitrogen dioxide NO₂ in the exhaust stream, so that the reductive reaction is impacted in a positive direction by the previous oxidation of NO into NO₂ in the coated diesel particulate filter (cDPF), or alternatively in the oxidation catalyst (DOC).

The reduction catalyst arrangement 220 requires additives to reduce the concentration of a compound, such as for example nitrogen oxides NOₓ, in the exhaust stream 203. Such additive is injected into the exhaust stream downstream of the particulate filter 210 and upstream of the reduction catalyst arrangement 220, shown in FIG. 2a as a dosing arrangement 270. Such additive is often ammonia and/or urea based, or consists of a substance from which ammonia may be extracted or released, and may for example consist of AdBlue, which basically consists of urea mixed with water. Urea forms ammonia at heating (thermolysis) and at heterogeneous catalysis on an oxidizing surface (hydrolysis), which surface may, for example, consist of titanium dioxide TiO2, within the reduction catalyst arrangement 220. The exhaust treatment system may also comprise a separate hydrolysis catalyst. The additive may be provided from a container/tank 275, and the dosing of the additive may be controlled by a control unit/system 290.

The exhaust treatment system 250 may also be equipped with a slip-catalyst (SC) 240, which is arranged downstream of the reduction catalyst arrangement 220 to oxidize an excess of ammonia that may remain after the reduction catalyst arrangement 220, an/or to assist the reduction catalyst arrangement 220 with further reduction of NOₓ. Accordingly, the slip-catalyst SC 240 may provide a potential for improving the system's total conversion/reduction of NOₓ.

According to an embodiment of the invention, an evaporation arrangement (not shown), e.g. a hydrolysis catalyst, which may comprise substantially any suitable hydrolysis coating, and/or a mixer, may be arranged at the dosing arrangement 270. The hydrolysis catalyst, and/or the mixer, are then used to increase the speed of the decomposition of urea into ammonia, and/or to mix the additive with the emissions, and/or to vaporise the additive.

The exhaust treatment system 250 may also be equipped with one or several sensors, such as one or several NOₓ and/or temperature sensors for the determination of nitrogen oxides and/or temperatures in the exhaust treatment system.

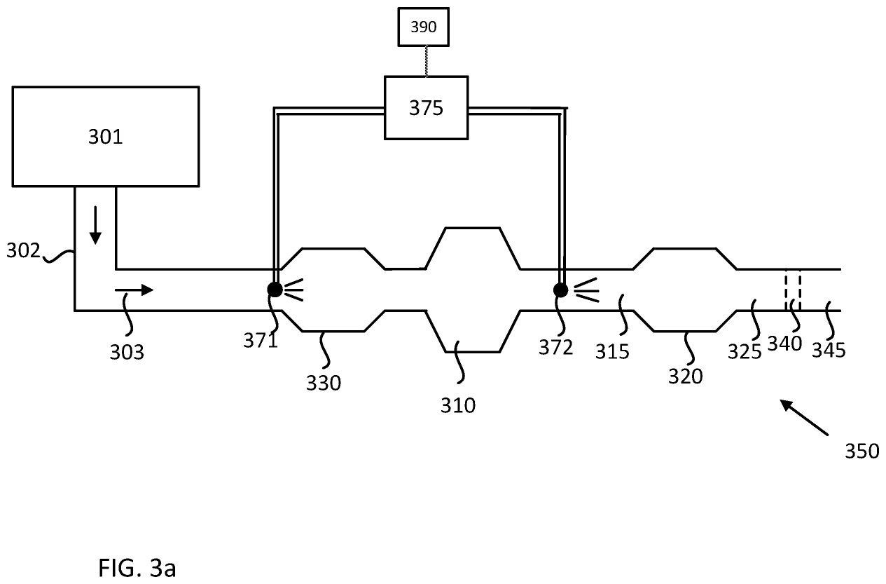

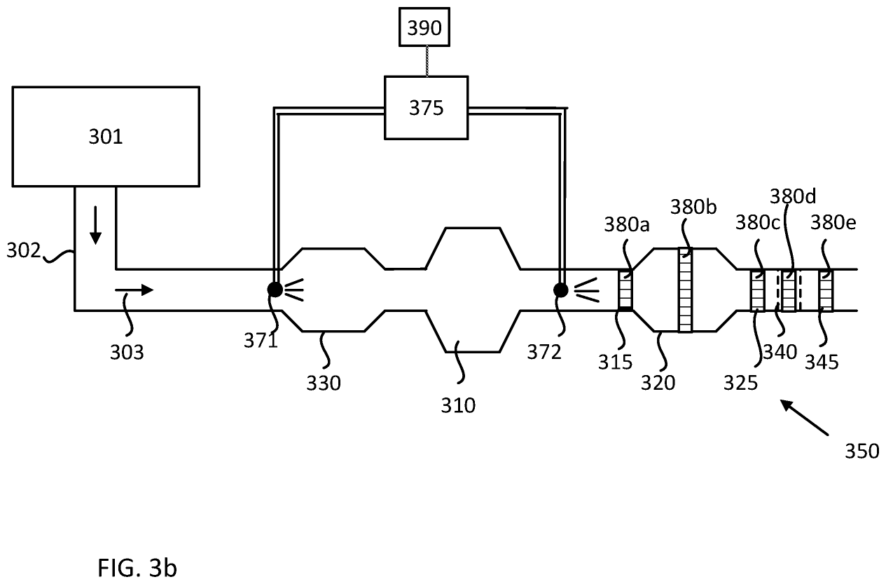

FIG. 3a schematically shows another exhaust treatment system 350, which is connected via an exhaust pipe 302 to a combustion engine 301. Exhausts are generated at combustion in the engine 301 and the exhaust stream 303 (indicated with arrows) is led to an upstream dosage device 371, arranged to add an additive into the exhaust stream 303. An upstream reduction catalyst device 330 is arranged downstream of the upstream dosage device 371. The upstream reduction catalyst device 330 is arranged to reduce nitrogen oxides NOₓ in the exhaust stream 303, through the use of the additive added to the exhaust stream by the upstream dosage device 371. In more detail, the upstream reduction catalyst device 330 uses the additive, for example ammonia NH₃, or a substance from which ammonia may be generated/formed/released, for the reduction of nitrogen oxides NOₓ in the exhaust stream 303. This additive may for example consist of the above mentioned AdBlue, and may be provided from a container/tank 375. The injection of the additive may be controlled by a control unit/system 390.

The upstream reduction catalyst device 330 may, according to various embodiments, comprise an upstream selective catalytic reduction (SCR) catalyst and/or an upstream slip catalyst. The upstream slip catalyst may be a conventional ammonia slip catalyst (ASC) or may be a multifunctional slip catalyst (SC), which is arranged primarily for reduction of nitrogen oxides NOₓ, and secondarily for oxidizing the additive in the exhaust stream 303.

The multifunctional slip catalyst (SC) includes a nitrogen oxides NOₓ reducing coating being in direct contact with the exhaust stream 303. The multifunctional slip catalyst (SC) also includes one or several substances comprised in platinum group metals, and/or one or several other substances that provide similar characteristics as for the platinum group metals.

Thus, according to various embodiments, the upstream reduction catalyst device 330 may e.g. comprise one of:
an upstream selective catalytic reduction catalyst SCR₁ followed downstream by an integrated or separate upstream slip-catalyst SC₁, wherein the upstream slip-catalyst SC₁ is arranged primarily for reduction of nitrogen oxides NOₓ, and secondarily for oxidation of a residue of additive in the exhaust stream 303;
an upstream slip-catalyst SC₁, followed downstream by an integrated or separate upstream selective catalytic reduction catalyst SCR₁, wherein the upstream slip-catalyst SC₁ is arranged primarily for reduction of nitrogen oxides NOₓ, and secondarily for oxidation of additive in the exhaust stream 303;
an upstream slip-catalyst SC₁, followed downstream by an integrated or separate upstream selective catalytic reduction catalyst SCR₁, followed downstream by an integrated or separate additional upstream slip-catalyst SC₁b, wherein the upstream slip-catalyst SC₁, and/or the additional upstream slip-catalyst SC₁b, are arranged primarily for reduction of nitrogen oxides NOₓ, and secondarily for oxidation of additive in the exhaust stream 303; and
an upstream slip-catalyst SC₁, which is primarily arranged for reduction of nitrogen oxides NOₓ, and secondarily for oxidation of a residue of additive in the exhaust stream 303.

Downstream of the upstream reduction catalyst device 330, the exhaust treatment system 350 further comprises a coated diesel particulate filter (cDPF) 310, which is coated with a catalytically oxidizing coating, for example comprising at least one precious metal for catching and oxidizing soot and ash. Alternatively, a diesel oxidation catalyst (DOC) followed downstream by a diesel particulate filter (DPF/cDPF) may be arranged in the exhaust treatment system 350 instead of the coated diesel particulate filter (cDPF). Thus, either of a coated diesel particulate filter (cDPF) 310 and a diesel oxidation catalyst (DOC) followed by a diesel particulate filter (DPF/cDPF) is arranged downstream of the upstream reduction catalyst device 330 in the exhaust treatment system 350.

Downstream of the particulate filter 310, the exhaust treatment system 350 comprises a downstream dosage device 372, which is arranged to supply additive to the exhaust stream 303, where such downstream additive comprises ammonia NH₃, or a substance, for example AdBlue, from which ammonia may be generated/formed/released, as described above. The downstream additive may here be the same additive as the above mentioned additive injected by the upstream dosage device 371, and may possibly also come from the same container/tank 375. Alternatively, the additives injected by the upstream 371 and downstream 372 dosage devices, respectively, may also be of different types and may come from different tanks. The injection by the downstream dosage device 372 may be controlled by a control unit/system 390.

According to an embodiment of the invention, an evaporation arrangement may be arranged at the upstream 371 and/or downstream 372 dosing arrangements, respectively, to increase the speed of the decomposition of urea into ammonia, and/or to mix the additive with the emissions, and/or to vaporise the additive.

The exhaust treatment system 350 also comprises a downstream reduction catalyst device 320, which is arranged downstream of the downstream dosage device 372. The downstream reduction catalyst device 320 is arranged to reduce nitrogen oxides NOₓ in the exhaust stream 303 through use of the additive injected by the downstream dosage device 372, and possibly also additive remaining in the exhaust stream 303 which was injected by the upstream dosage device 371.

The downstream reduction catalyst device 320 may comprise at least one selective catalytic reduction catalyst and/or at least one slip catalyst.

Thus, according to various embodiments, the downstream reduction catalyst device 320 may comprise one of:
a downstream selective catalytic reduction catalyst SCR₂; and
a downstream selective catalytic reduction catalyst SCR₂, downstream followed by an integrated or separate downstream slip-catalyst SC₂, wherein the downstream slip-catalyst SC₂ is arranged to oxidize a residue of additive and/or to assist SCR₂ with an additional reduction of nitrogen oxides NOₓ in the exhaust stream 303.

After passing through the components of the exhaust treatment system, the exhaust stream is emitted into the environment at the tailpipe of the exhaust treatment system.

The exhaust treatment system 350 may also be equipped with one or several sensors (not shown), such as one or several NOₓ sensors and/or one or several temperature sensors, which are arranged for the determination of NOₓ-concentrations and temperatures in the exhaust treatment system 350, respectively.

Through the use of the exhaust treatment system 350 shown in FIG. 3a, both the upstream reduction catalyst device 330 and the downstream reduction catalyst device 320 may be optimized with respect to a selection of catalyst characteristics for the reduction of nitrogen oxides NOₓ, and/or with respect to volumes for the upstream 330 and downstream 320 reduction catalyst devices, respectively.

The particulate filter 310 may hereby be used to improve the efficiency, by taking into account how its thermal mass, i.e. its thermal inertia, impacts the temperature of the downstream reduction catalyst 320. By taking into account the thermal inertia of the particulate filter 310, the upstream reduction catalyst device 330 and the downstream reduction catalyst device 320, respectively, may be optimized with respect to the specific temperature function each will experience.

The exhaust treatment system 350 reduces the amount of nitrogen oxides NOₓ in the exhaust stream in substantially all driving modes, comprising especially cold starts and throttle, that is to say increased requested torque.

The above mentioned slip-catalyst SC may, according to various embodiments, be a catalyst, which is arranged to oxidize additive in the exhaust stream 303, and/or which is arranged so that it is able to reduce residual nitrogen oxides NOₓ in the exhaust stream 303.

In more detail, such a slip-catalyst SC may e.g. according to various embodiments be arranged primarily to reduce nitrogen oxides NOₓ, and secondarily to oxidize additive. In other words, the slip-catalyst SC may take care of slip-residues of both additive and nitrogen oxides NOₓ. This may also be described as the slip-catalyst SC being an extended ammonia slip-catalyst ASC, which is set up to reduce nitrogen oxides NOₓ in the exhaust stream 303, so that a general/multifunctional slip-catalyst SC is obtained, which takes care of several types of slip, meaning that it takes care of residues of both additive and nitrogen oxides NOₓ. At least the following reactions may for example be carried out in a multifunctional slip-catalyst SC, which both reduces nitrogen oxides NOₓ and oxidizes additive:

$${NH}_{3} + {O}_{2} \to {N}_{2} ; \qquad ( Equation 1 )$$

$$and$$

$${NO}_{x} + {NH}_{3} \to {N}_{2} + {H}_{2} O . \qquad ( Equation 2 )$$

Here, the reaction according to equation 1 results in an oxidation of residue of additive, comprising ammonia. The reaction according to equation 2 results in a reduction of nitrogen oxides NOₓ.

Accordingly, the additive may here be oxidized, as well as residues of ammonia NH₃, isocyanic acid HNCO, urea or similar may be oxidized. These residues of additive, that is to say ammonia NH₃, HNCO, urea or similar, may here also be used to oxidize nitrogen oxides NOₓ.

In order to obtain these characteristics, that is to say, to obtain a multifunctional slip-catalyst, the slip-catalyst may according to one embodiment comprise one or several substances comprised in platinum metals (PGM; Platinum Group Metals), that is to say, one or several of iridium, osmium, palladium, platinum, rhodium and ruthenium. The slip-catalyst may also comprise one or several other substances, which give the slip-catalyst similar characteristics as platinum group metals. The slip-catalyst may also comprise an NOₓ-reducing coating, where the coating may for example comprise Cu- or Fe-Zeolite or vanadium. Zeolite may here be activated with an active metal, such as for example copper (Cu) or iron (Fe).

For each one of the upstream 330 and the downstream 320 reduction catalyst device, its catalytic characteristics may be selected based on the environment to which it is exposed, or will be exposed to. Additionally, the catalytic characteristics for the upstream 330 and the downstream 320 reduction catalyst device may be adapted so that they may be allowed to operate in symbiosis with each other. The upstream 330 and the downstream 320 reduction catalyst device may also comprise one or several materials, providing the catalytic characteristic. For example, transition metals such as vanadium and/or tungsten may be used, for example in a catalyst comprising V₂O₅/WO₃/TiO₂. Metals such as iron and/or copper may also be comprised in the upstream 310 and/or downstream 320 reduction catalyst device, for example in a Zeolite-based catalyst.

According to the present invention, at least one exhaust stream interaction arrangement 280a-e, 380a-e, comprising at least one filter/filtering structure, is arranged downstream of the dosing arrangement 270, 372 to interact with certain small-sized particles in the exhaust stream 203, 303. These particles may be created by the supply of the additive into the exhaust stream 203, 303 and/or by a transformation of the additive when the additive is flowing through the exhaust treatment system 250, 350, as mentioned above. The particles may comprise urea and/or polymeric biproducts based on urea.

The at least one filter structure 280a-e, 380a-e has a cross section area A in inches² and a length L in inches resulting in an area to length ratio A/L having a value of at least 17 inches; A/L≥17 inches. The at least one filter structure 280a-e, 380a-e further has an opening degree such that the particles are caused to interact with the at least one filter structure 280a-e, 380a-e, whereby the particles are at least partly captured and removed from the exhaust stream 203, 303. The opening degree is also chosen such that accumulation of soot and ash created by the combustion is at least partly avoided, such that the interaction of the at least one filter structure 280a-e, 380a-e and the particles is not affected.

The opening degree is a measure of how obstructed the exhaust stream is by the at least one filter structure 280a-e, 380a-e along the length L of the at least one filter structure 280a-e, 380a-e. Thus, the opening degree indicates to which degree, i.e. to which extent, the one or more flow paths through the at least one filter structure 280a-e, 380a-e are obstructed.

For example, for those embodiments wherein the at least one filter structure 280a-e, 380a-e comprises a filter structure, the one or more flow paths through the at least one filter structure 280a-e, 380a-e may comprise filter channels through the structure of the at least one filter structure 280a-e, 380a-e. Then, if at least one of the one or more flow paths, i.e. if at least one of the one or more filter channels, is obstructed/plugged anywhere along its length L, this decreases the opening degree of the at least one filter structure 280a-e, 380a-e.

It should be noted that the opening degree thus takes obstructions/plugs in any position along the whole length of the flow paths of the at least one filter structure 280a-e, 380a-e into account, and therefore provides a general measure/ratio of how obstructed the exhaust stream flow through the at least one filter structure 280a-e, 380a-e is. The opening degree may be defined as a ratio between the cross section area Aₒ of open, i.e. unobstructed flow paths, and a total cross section area Aₜₒₜ of the component; Aₒ/Aₜₒₜ.

It should be noted that the herein defined opening degree differs from the known open frontal area (OFA) ratio, which is defined as the ratio between a catalyst or monolith free cross-section and the overall cross-section, in the front or opening of the catalyst or monolith. Thus, the open frontal area ratio does not take obstructions in a component being located downstream of its front or opening into account.

The herein defined opening degree (OD), on the other hand, is, as explained above, not limited to only the front section of a component. Instead, the opening degree takes into account if a flow path is obstructed in the flow direction in any position along the length L of the component. The more flow paths being obstructed, the lower will the opening degree value be. Also, by decreasing the opening degree, the interaction between the gas flow, and in particular its constituents such as the additive based particles, and the component is increased. Also, the pressure drop over the component is typically increasing with decreasing opening degrees.

Thus, lower values for the opening degrees for the least one filter structure 280a-e, 380a-e causes more interaction between the additive based particles and the least one filter structure 280a-e, 380a-e than higher values do, and thus results in more additive based particles being captured and dissolved.

For example, for embodiments where the least one filter structure 280a-e, 380a-e comprises a closed filter structure, the opening degree has a value of zero; OD=0%, since the whole exhaust stream is then forced to pass through, and to interact with, one or more walls of the filter structure. Such a closed filter structure may also be denoted wall-flow filter, which according to this definition, has an opening degree being zero; OD=0%.

Conversely, for embodiments where the least one filter structure 280a-e, 380a-e comprises an open filter structure, i.e. a so-called flow-through substrate/monolith, the opening degree may have a value of approximately 80%; OD=80%; depending on its design, such as e.g. wall thickness and channel layout.

According to an embodiment, the area to length ratio A/L in inches for the at least one filter structure 280a-e, 380a-e has a value of at most 50; 17≤A/L≤50 inches. This interval for the area to length ratio A/L may e.g. be used for embodiments where the at least one filter structure 280a-e, 380a-e comprises a closed filter structure, as explained below.

The at least one filter structure may have a number of different shapes. According to various embodiments, the at least one filter structure 280a-e, 380a-e has a circular cross-section, has an oval cross-section, has a rectangular cross-section, or has another suitable form. The cross section of the at least one filter structure may have essentially any shape being suitable for connecting the at least one filter structure to upstream and/or downstream components in the exhaust treatment system 250, 350.

The important thing is the ratio between the area A of the cross section and the length L of the at least one filter structure. The at least one filter structure should have a shorter length L in relation to the area A than filter structures of conventional particulate filters have.

As stated above, the area to length ratio A/L may, for some embodiments, be in the interval of 17≤A/L≤50 inches, if the area A is measured in inches² and the length L is measured in inches. This corresponds to an area to length ratio A/L interval of 432≤A/L≤1270 mm, if the area A is measured in mm² and the length L is measured in mm.

According to an embodiment, the at least one filter structure 280a-e, 380a-e is arranged at least 0.1 meter downstream of the dosing arrangement, i.e. downstream of the dosing arrangement 270 shown in FIG. 2b or downstream of the downstream dosing device 372 shown in FIG. 3b, respectively. For example, the at least one filter structure 280a-e, 380a-e may be arranged at least 0.5 meter downstream of the dosing arrangement, or any other suitable distance downstream of the dosing arrangement such that it does not interfere with the injection of the additive.

According to various embodiment, where the at least one filter structure 280e, 380e is arranged downstream of the reduction catalyst arrangement 220, the downstream reduction catalyst device 320 and/or the slip catalyst 240, 340, the at least one filter structure 280e, 380e may be arranged at least 1.5 meter downstream of the dosing arrangement 270 shown in FIG. 2b or 1.5 meter downstream of the downstream dosing device 372 shown in FIG. 3b, respectively. For e.g. exhaust treatment systems having a vertical tailpipe, the at least one filter structure 280e, 380e may be arranged at least 3 meters downstream of the dosing arrangement 270 shown in FIG. 2b or at least 3 meters downstream of the downstream dosing device 372 shown in FIG. 3b, respectively.

According to an embodiment, if the exhaust treatment system 250 shown in FIG. 2b comprises an evaporation arrangement arranged at the dosing arrangement 270, or if the exhaust treatment system 350 shown in FIG. 3b comprises an evaporation arrangement arranged at the downstream dosing device 372, then the at least one filter structure 280a-e, 380a-e is arranged downstream of that evaporation arrangement.

According to an embodiment, the at least one filter structure 280a is arranged 215 downstream of the dosing arrangement 270 and upstream of the reduction catalyst arrangement 220, as shown in FIG. 2b.

According to an embodiment, the at least one filter structure 380a is arranged 315 downstream of the downstream dosing device 372 and upstream of the downstream reduction catalyst device 320, as shown in FIG. 3b.

According to an embodiment, the at least one filter structure 280b is comprised in the reduction catalyst arrangement 220, as shown in FIG. 2b.

According to an embodiment, the at least one filter structure 380b is comprised in the downstream reduction catalyst device 320, as shown in FIG. 3b.

According to an embodiment, the at least one filter structure 280c-e is arranged 225, 240, 245 downstream of the reduction catalyst arrangement 220, as shown in FIG. 2b.

According to an embodiment, the at least one filter structure 380c-e is arranged 325, 340, 345 downstream of the downstream reduction catalyst device 320, as shown in FIG. 3b.

According to an embodiment, the at least one filter structure 280c is arranged 225 downstream of the reduction catalyst arrangement 220 and upstream of the slip catalyst arrangement 240, as shown in FIG. 2b.

According to an embodiment, the at least one filter structure 380c is arranged 325 downstream of the downstream reduction catalyst device 320 and upstream of the slip catalyst arrangement 340, as shown in FIG. 3b.

According to an embodiment, the at least one filter structure 280d is arranged comprised in the slip catalyst arrangement 240, as shown in FIG. 2b.

According to an embodiment, the at least one filter structure 380d is arranged comprised in the slip catalyst arrangement 340, as shown in FIG. 3b.

According to an embodiment, the at least one filter structure 280e is arranged downstream 245 of the slip catalyst arrangement 240, as shown in FIG. 2b.

According to an embodiment, the at least one filter structure 380e is arranged downstream 345 of the slip catalyst arrangement 340, as shown in FIG. 3b.

The filter structure may, according to some embodiments, be a closed filter structure. Thus, the filter structure may comprise channels through the filter, where each such channel is closed/plugged at one or more of its ends, or between the ends. There are in other words no open, i.e. non-plugged, channels that lead through the filter, because each channel is closed/plugged in one or both of its ends, or between the ends. Each channel in the filter is thus closed somewhere along its length, i.e. at its upstream end, at its downstream end and/or between its upstream and downstream ends.

According to an embodiment, the area to length ratio A/L in inches for the at least one filter structure 280a-e, 380a-e has a value of at most 50; 17≤A/L≤50 inches. This interval for the area to length ratio A/L may e.g. be used for embodiments where the at least one filter structure 280a-e, 380a-e comprises a closed filter structure.

According to other embodiments, the filter structure comprises one or more channels being open through the filter structure. This means that the filter is at least partly open, i.e. the filter is not completely closed.

For an at least partly open filter structure, the area to length ratio A/L has, according to an embodiment, a value of at least 17 inches and at most 100 inches; 17≤A/L≤100 inches.

According to an embodiment, the opening degree of the at least one filter structure 280a-e, 380a-e for the non-closed filter is in one of the intervals in the group of:
1% to 80%;
10% to 80%;
20% to 80%;
10% to 60%;
20% to 60%;
10% to 50%;
20% to 50%; and
30% to 50%.

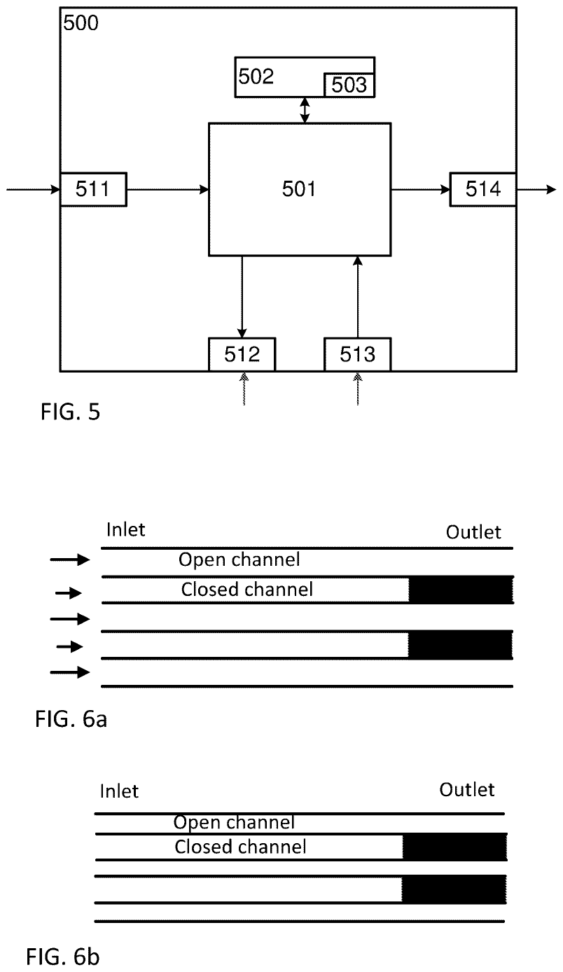

As shown in FIGS. 6a-b, the channels through a filter structure may be symmetrically (FIG. 6a) or asymmetrically (FIG. 6b) designed regarding their cross section areas.

According to an embodiment, illustrated in FIG. 6a, the filter structure comprises at least one open channel and at least one closed channel through the filter structure. An open channel cross section area A_{oc} of the at least one open channel is here essentially equal to a closed channel cross section area A_{cc} of the at least one closed channel. Thus, there is no intentional difference between the cross-section areas of the open A_{oc} and closed A_{cc} channels, respectively. This may be denoted as a symmetrical design of the filter structure.

According to another embodiment, illustrated in FIG. 6b, the open channel cross section area A_{oc} of the at least one open channel is here instead different from the closed channel cross section area A_{cc} of the at least one closed channel. Thus, the cross section areas of the open A_{oc} and closed A_{cc} channels, respectively, are designed to differ. For example, the open channel cross section area A_{oc} may be smaller than the closed channel cross section area A_{cc}. This may be denoted as an asymmetrical design of the filter structure.

It should be noted that the filter structure shown in FIG. 6a has a higher opening degree than the filter shown in FIG. 6b. It should also be noted that, according to the open frontal area (OFA) ratio definition, the filter structures shown in FIGS. 6a-b would have the same open frontal area ratio.

By choosing the filter design, i.e. by choosing a symmetrical or an asymmetrical filter design, an opening degree matching a specific implementation may be achieved, such that an efficient removal of the additive based particles is provided.

According to an embodiment, the at least one filter structure has an asymmetry ratio between the cross section area for the at least one closed channel A_{cc} and the cross section area for the at least one open channel A_{oc}, respectively, having a value of at least 1.3; A_{cc}/A_{oc}≥1.3. By increasing the asymmetry with a ratio value being above 1, the opening degree is reduced and the interaction between the filter structure and additive based particles in the exhaust stream is increased. Hereby, the filtration of these particles is increased, resulting in an increased capturing and/or removal of the particles.

According to an embodiment, the at least one filter structure 280a-e, 380a-e comprises at least one section arranged to be heated by the exhaust stream 203, 303 to an interaction temperature T_{I} when the exhaust stream flows through the at least one filter structure 280a-e, 380a-e. The interaction temperature T_{I} hereby exceeds a particle temperature T_{P} at which the particles thermally dissolve; T_{I}>T_{P}. Also, the at least one filter structure 280a-e, 380a-e is arranged, by its opening degree, to interact with the exhaust stream 203, 303, and thus also with the additive based particles, such that at least a portion of the particles comes in physical contact with the heated at least one section. Hereby, the additive based particles hitting the at least one heated section are thermally dissolved and removed from the exhaust stream. The interaction temperature T_{I} may, according to an embodiment, be at least 150° C.

At a cold start, i.e. before the at least one section has been heated to the interaction temperature T_{I}, then some particles may initially be accumulated in the at least one filter structure 280a-e, 380a-e. However, when the at least one section has been heated to the interaction temperature T_{I}, the accumulated additive based particles are thermally dissolved and removed.

According to an embodiment, the at least one filter structure 280a-e, 380a-e at least partially comprises an inert material, i.e. comprises a chemically inactive material, which is not prone to be involved in chemical reactions. The at least one filter structure 280a-e, 380a-e may be made of the inert material, or the inert material may be coated on the at least one filter structure 280a-e, 380a-e. The inert material may be a metallic and/or a non-metallic material, for example cordierite, silicon carbide, aluminum titanate and/or polymer composites.

According to an embodiment, the at least one filter structure 280a-e, 380a-e at least partially comprises an active catalytic material. The at least one filter structure 280a-e, 380a-e may be made of the active catalytic material, or the active catalytic material may be coated on the at least one filter structure 280a-e, 380a-e. The active catalytic material may be for example precious metals, Vanadium, Iron (Fe), Copper, Titanium, Tungsten and/or Aluminium.

According to an aspect of the present invention, a method for treatment of an exhaust stream 203, 303 resulting from a combustion in a combustion engine 201, 301.

In a first step 410, soot and ash created by the combustion are caught by utilization of a particulate filter 210, 310.

In a second step 420, a supply of an additive into the exhaust stream by utilization of a dosing arrangement 270, 372 arranged downstream of the particulate filter 210, 310 is controlled.

In a third step 430, nitrogen oxides NOₓ in the exhaust stream 203, 303 are reduced by utilization of the supplied additive and a reduction catalyst arrangement 220, 320 arranged downstream of the dosing arrangement 270, 372.

In a fourth step 440, particles in the exhaust stream 203, 303 are caused to interact with at least one filter structure 280a-e, 380a-e arranged downstream of the dosing arrangement 270, 372. These particles are, as described above, created by one or more of the supply of the additive into the exhaust stream 203, 303 and a transformation of the additive when flowing through the exhaust treatment system 250, 350. The at least one filter structure 280a-e, 380a-e has a cross section area A in inches² and a length L in inches resulting in an area to length ratio A/L having a value of at least 14 inches; A/L≥17 inches; and has an opening degree such that:
the particles are caused to interact with the at least one filter structure 280a-e, 380a-e, thereby being at least partly captured and removed by the at least one filter structure 280a-e, 380a-e; and
accumulation of soot and ash created by the combustion, which would affect the interaction of the at least one filter structure 280a-e, 380a-e and the particles, is at least partly avoided.

A person skilled in the art will realize that a method for treatment of an exhaust stream according to the present invention may also be implemented in a computer program, which when executed in a computer will cause the computer to execute the method. The computer program usually forms a part of a computer program product 503, wherein the computer program product comprises a suitable digital non-volatile/permanent/persistent/durable storage medium on which the computer program is stored. Said non-volatile/permanent/persistent/durable computer readable medium consists of a suitable memory, e.g.: ROM (Read-Only Memory), PROM (Programmable Read-Only Memory), EPROM (Erasable PROM), Flash, EEPROM (Electrically Erasable PROM), a hard disk device, etc.

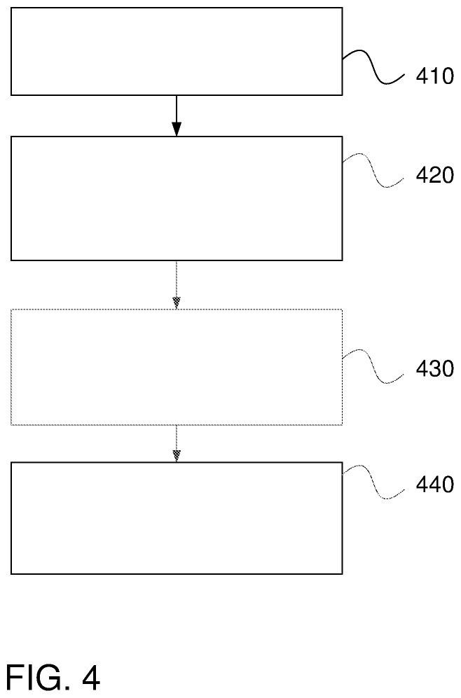

FIG. 5 schematically shows a control device 500. The control device 500 comprises a calculation unit 501, which may consist of essentially a suitable type of processor or microcomputer, e.g. a circuit for digital signal processing (Digital Signal Processor, DSP), or a circuit with a predetermined specific function (Application Specific Integrated Circuit, ASIC). The calculation unit 501 is connected to a memory unit 502, installed in the control device 500, providing the calculation device 501 with e.g. the stored program code and/or the stored data, which the calculation device 501 needs in order to be able to carry out calculations. The calculation unit 501 is also set up to store interim or final results of calculations in the memory unit 502.

Further, the control device 500 is equipped with devices 511, 512, 513, 514 for receiving and sending of input and output signals, respectively. These input and output signals may contain wave shapes, pulses, or other attributes, which may be detected as information by the devices 511, 513 for the receipt of input signals, and may be converted into signals that may be processed by the calculation unit 501. These signals are then provided to the calculation unit 501. The devices 512, 514 for sending output signals are arranged to convert the calculation result from the calculation unit 501 into output signals for transfer to other parts of the vehicle's control system, and/or the component(s) for which the signals are intended.

Each one of the connections to the devices for receiving and sending of input and output signals may consist of one or several of a cable; a data bus, such as a CAN (Controller Area Network) bus, a MOST (Media Oriented Systems Transport) bus, or any other bus configuration; or of a wireless connection.

A person skilled in the art will realize that the above-mentioned computer may consist of the calculation unit 501, and that the above-mentioned memory may consist of the memory unit 502.

Generally, control systems in modern vehicles consist of a communications bus system, consisting of one or several communications buses to connect a number of electronic control devices (ECUs), or controllers, and different components localised on the vehicle. Such a control system may comprise a large number of control devices, and the responsibility for a specific function may be distributed among more than one control device. Vehicles of the type shown, thus often comprise significantly more control devices than what is shown in FIG. 5, which is well known to a person skilled in the art within the technology area.

As a person skilled in the art will realize, the control device 500 in FIG. 5 may comprise one or several of the control devices 290 and 390 in FIGS. 2a-b and 3a-b, respectively.

The present invention, in the embodiment shown, is implemented in the control device 500. The invention may, however, also be implemented wholly or partly in one or several other control devices, already existing in the vehicle, or in a control device dedicated to the present invention.

A person skilled in the art will also realize that the above exhaust treatment system may be modified according to the different embodiments of the method according to the invention. In addition, the invention relates to the motor vehicle 100, for example a car, a truck or a bus, or another unit comprising at least one exhaust treatment system according to the invention, such as for example a vessel or a voltage/current-generator.

The present invention is not limited to the embodiments of the invention described above, but relates to and comprises all embodiments within the scope of the enclosed independent claims.

1. An exhaust treatment system arranged for treatment of an exhaust stream resulting from a combustion in a combustion engine, the exhaust treatment system comprising:
a particulate filter arranged to catch soot and ash created by the combustion;
a dosing arrangement arranged downstream of the particulate filter to supply an additive into the exhaust stream;
a reduction catalyst arrangement arranged downstream of the dosing arrangement for reduction of nitrogen oxides NOₓ in the exhaust stream by utilization of the supplied additive; and
at least one filter structure arranged downstream of the dosing arrangement to interact with particles in the exhaust stream, the particles being created by one or more of the supply of the additive into the exhaust stream and a transformation of the additive when flowing through the exhaust treatment system, wherein the at least one filter structure has a cross section area A in inches² and a length L in inches resulting in an area to length ratio A/L having a value of at least 17 inches; A/L≥17 inches, and has an opening degree such that:
the particles are caused to interact with the at least one filter structure, thereby being at least partly captured and removed from the exhaust stream; and
accumulation of soot and ash created by the combustion, which would affect the interaction of the at least one filter structure and the particles, is at least partly avoided.

2. The exhaust treatment system as claimed in claim 1, wherein the at least one filter structure is closed.

3. The exhaust treatment system as claimed in claim 1, wherein the at least one filter structure comprises channels, each channel being closed at one or more in the group of:
at its upstream end;
at its downstream end; and
between its upstream and downstream ends.

4. The exhaust treatment system as claimed in claim 3, wherein the opening degree of the at least one filter structure is zero.

5. The exhaust treatment system as claimed in claim 2, wherein the area to length ratio A/L in inches for the at least one filter structure has a value of at most 50; 17≤A/L≤50 inches.

6. The exhaust treatment system as claimed in claim 1, wherein the at least one filter structure comprises one or more channels being open through the filter structure.

7. The exhaust treatment system as claimed in claim 6, wherein the opening degree of the at least one filter structure is in one of the intervals in the group of:
1% to 80%:
10% to 80%;
20% to 80%;
10% to 60%;
20% to 60%;
10% to 50%;
20% to 50%; and
30% to 50%.

8. The exhaust treatment system as claimed in claim 6, wherein the area to length ratio A/L for the at least one filter structure has a value of at least 17 inches and at most 100 inches; 17≤A/L≤100 inches.

9. The exhaust treatment system as claimed in claim 1, wherein:
the at least one filter structure comprises at least one open channel and at least one closed channel through the at least one filter structure;
the at least one open channel has an open channel cross section area A_{oc}; and
the at least one closed channel has a closed channel cross section area A_{cc}, the closed channel cross section area A_{cc} being equal to the open channel cross section area A_{oc}; A_{oc}=A_{cc}.

10. The exhaust treatment system as claimed in claim 1, wherein:
the at least one filter structure comprises at least one open channel and at least one closed channel through the at least one filter structure;
the at least one open channel has an open channel cross section area A_{oc}; and
the at least one closed channel has a closed channel cross section area A_{cc}, the closed channel cross section area A_{cc} being different from the open channel cross section area A_{oc}.

11. The exhaust treatment system as claimed in claim 1, wherein the at least one filter structure is arranged at least 0.1 meter downstream of the dosing arrangement.

12. The exhaust treatment system as claimed in claim 1, further comprising an evaporation arrangement arranged at the dosing arrangement, wherein the at least one filter structure is arranged downstream of the evaporation arrangement.

13. The exhaust treatment system as claimed in claim 1, wherein the at least one filter structure is arranged upstream of the reduction catalyst arrangement.

14. The exhaust treatment system as claimed in claim 1, wherein the at least one filter structure is comprised in the reduction catalyst arrangement.

15. The exhaust treatment system as claimed in claim 1, wherein the at least one filter structure is arranged downstream of the reduction catalyst arrangement.

16. The exhaust treatment system as claimed in claim 1, further comprising a slip catalyst arrangement arranged downstream of the reduction catalyst arrangement for oxidation of a residue of additive in the exhaust stream, wherein the at least one filter structure is arranged downstream of the reduction catalyst arrangement and upstream of the slip catalyst arrangement.

17. The exhaust treatment system as claimed in claim 1, further comprising a slip catalyst arrangement arranged downstream of the reduction catalyst arrangement for oxidation of a residue of additive in the exhaust stream, wherein the at least one filter structure is comprised in the slip catalyst arrangement.

18. The exhaust treatment system as claimed in claim 1, further comprising a slip catalyst arrangement arranged downstream of the reduction catalyst arrangement for oxidation of a residue of additive in the exhaust stream, wherein the at least one filter structure is arranged downstream of the slip catalyst arrangement.

19. The exhaust treatment system as claimed in claim 1, wherein the reduction catalyst arrangement comprises one or more in the group of:
at least one selective catalytic reduction catalyst;
at least one slip catalyst.

20. The exhaust treatment system as claimed in claim 1, wherein:
the at least one filter structure comprises at least one section arranged to be heated to an interaction temperature T_{I} by the exhaust stream flowing through it, the interaction temperature T_{I} exceeding a particle temperature T_{P} at which the particles thermally dissolve; T_{I}>T_{P}; and
the at least one filter structure is arranged to interact with the particles such that the particles at least partly come in physical contact with the heated at least one section.

21. The exhaust treatment system as claimed in claim 20, wherein the interaction temperature T_{I} is at least 150° C.

22. The exhaust treatment system as claimed in claim 1, wherein the at least one filter structure at least partially comprises an inert material.

23. The exhaust treatment system as claimed in claim 22, wherein the inert material is one or more in the group of:
a metallic material; and
a non-metallic material.

24. The exhaust treatment system as claimed in claim 1, wherein the at least one filter structure at least partially comprises an active catalytic material.

25. The exhaust treatment system as claimed in claim 22, wherein the material is coated on the at least one filter structure.

26. The exhaust treatment system as claimed in claim 1 any one of claims 1-25, wherein the additive comprises one or more in the group of:
ammonia, and
a substance from which ammonia may be extracted and/or released.

27. The exhaust treatment system as claimed in claim 1, wherein the particles comprise one or more in the group of:
urea; and
polymeric biproducts based on urea.

28. The exhaust treatment system as claimed in claim 1, comprising:
an upstream dosing device arranged to supply an additive into the exhaust stream;
an upstream reduction catalyst device arranged downstream of the upstream dosing device for reduction of nitrogen oxides NOₓ in the exhaust stream by utilizing the supplied additive;
the particulate filter arranged downstream of the upstream reduction catalyst device to catch soot and ash created by the combustion;
the dosing arrangement arranged as a downstream dosing device downstream of the particulate filter to supply an additive into the exhaust stream;
the reduction catalyst arrangement arranged as a downstream reduction catalyst device downstream of the downstream dosing device to reduce nitrogen oxides NOₓ in the exhaust stream by utilizing the supplied additive; and
the least one filter structure arranged downstream of the downstream dosing device.

29. The exhaust treatment system as claimed in claim 28, wherein the upstream reduction catalyst device comprises one or more in the group of:
an upstream selective catalytic reduction catalyst; and
an upstream slip catalyst.

30. A method for treatment of an exhaust stream resulting from a combustion in a combustion engine, the method comprising:
catching soot and ash created by the combustion by utilization of a particulate filter;
controlling a supply of an additive into the exhaust stream by utilization of a dosing arrangement arranged downstream of the particulate filter;
reduction of nitrogen oxides NOₓ in the exhaust stream by utilization of the supplied additive and a reduction catalyst arrangement arranged downstream of the dosing arrangement; and
interaction of particles in the exhaust stream and at least one filter structure arranged downstream of the dosing arrangement, the particles being created by one or more of the supply of the additive into the exhaust stream and a transformation of the additive when flowing through the exhaust treatment system, wherein the at least one filter structure has a cross section area A in inches² and a length L in inches resulting in an area to length ratio A/L having a value of at least 14 inches; A/L≥17 inches; and has an opening degree such that:
the particles are caused to interact with the at least one filter structure, thereby being at least partly captured and removed by the at least one filter structure; and
accumulation of soot and ash created by the combustion, which would affect the interaction of the at least one filter structure and the particles, is at least partly avoided.

32. A computer program A computer program product stored on a non-transitory computer-readable medium, said computer program product for treatment of an exhaust stream resulting from a combustion in a combustion engine, wherein said computer program product comprising computer instructions to cause one or more computer processors to perform the following operations:
controlling a supply of an additive into the exhaust stream by utilization of a dosing arrangement arranged downstream of a particulate filter used to catch soot and ash created by the combustion;
reduction of nitrogen oxides NOₓ in the exhaust stream by utilization of the supplied additive and a reduction catalyst arrangement arranged downstream of the dosing arrangement; and
interaction of particles in the exhaust stream and at least one filter structure arranged downstream of the dosing arrangement, the particles being created by one or more of the supply of the additive into the exhaust stream and a transformation of the additive when flowing through the exhaust treatment system, wherein the at least one filter structure has a cross section area A in inches² and a length L in inches resulting in an area to length ratio A/L having a value of at least 14 inches; A/L≥17 inches; and has an opening degree such that:
the particles are caused to interact with the at least one filter structure, thereby being at least partly captured and removed by the at least one filter structure; and
accumulation of soot and ash created by the combustion, which would affect the interaction of the at least one filter structure and the particles, is at least partly avoided.

33. (canceled)

34. A control system arranged for controlling an exhaust treatment system for treatment of an exhaust stream resulting from a combustion in a combustion engine, the treatment comprising:
catching soot and ash created by the combustion by utilization of a particulate filter;
controlling a supply of an additive into the exhaust stream by utilization of a dosing arrangement arranged downstream of the particulate filter;
reduction of nitrogen oxides NOₓ in the exhaust stream by utilization of the supplied additive and a reduction catalyst arrangement arranged downstream of the dosing arrangement; and
interaction of particles in the exhaust stream and at least one filter structure arranged downstream of the dosing arrangement, the particles being created by one or more of the supply of the additive into the exhaust stream and a transformation of the additive when flowing through the exhaust treatment system, wherein the at least one filter structure has a cross section area A in inches² and a length L in inches resulting in an area to length ratio A/L having a value of at least 14 inches; A/L≥17 inches; and has an opening degree such that:
the particles are caused to interact with the at least one filter structure, thereby being at least partly captured and removed by the at least one filter structure; and
accumulation of soot and ash created by the combustion, which would affect the interaction of the at least one filter structure and the particles, is at least partly avoided.
